(19) United States
(12) Patent Application Publication
(10) Pub. No.: US 2026/0276961 A1
(43) Pub. Date: Sep. 17, 2026

(54) AIR TOLERANT PHOTOCATHODE ELECTRON GUN

(71) Applicant: NOVA MEASURING INSTRUMENTS INC., Fremont, CA (US)

(72) Inventors: Rudy Garcia, Union City, CA (US); Gary Lopez Lopez, Fremont, CA (US); Gildardo DELGADO, Livermore, CA (US)

(73) Assignee: NOVA MEASURING INSTRUMENTS INC., Fremont, CA (US)

(21) Appl. No.: 19/167,383

(22) PCT Filed: Mar. 25, 2024
(86) PCT No.: PCT/IB2024/052856

§ 371 Date: Sep. 21, 2025

Related U.S. Application Data
(60) Provisional application No. 63/492,204, filed on Mar. 24, 2023.

(51) Int. Cl. G02B 19/00; G02B 27/09; H01J 35/06

(52) U.S. Cl. CPC G02B 19/0047; G02B 27/0927; H01J 35/065

(57) ABSTRACT

optics that includes a photocathode and light optics configured to direct a light beam towards the photocathode, the light beam forms a sub-micron spot on the photocathode. The photocathode is air tolerant, is made of a material selected of Na₂O, K₂O and Rb₂O, and is configured to convert the light beam to an electron beam.

### CROSS REFERENCE

This application claims priority from U.S. provisional patent Ser. No. 63/492,204 filing date Mar. 24, 2023, which is incorporated herein in its entirety.

### BACKGROUND OF THE INVENTION

A thermionic emitter is an electron source that uses heat to give the electrons enough energy to overcome the work function of the material and “boil” into the vacuum. However, it might to operate at extremely high temperature (around 1550° C.) and the resultant electron beam has a high thermal emittance that produces a beam with Gaussian cross section that is difficult to be focused and melts the anode used to produce X-rays. Currently, the focus spot at the anode must be moved every few minutes to keep the X-ray constant as the electron beam melts the anode surface.

There is a growing need to provide a more durable electron source.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of intrinsic thermal emittance predictions;

FIG. 2 illustrates an example of parts of optics;

FIG. 3 illustrates an example of parts of optics;

FIG. 4 illustrates examples of photocathode guns;

FIG. 5 illustrates an example of a photocathode electron gun that is followed by an anode;

FIG. 6 illustrates an example of a method; and

FIG. 7 is an example of a position of the photocathode gun in a system.

### DETAILED DESCRIPTION OF THE DRAWINGS

According to an embodiment there is provided optics that includes a photocathode, and light optics configured to direct a light beam towards the photocathode. The light beam forms a sub-micron spot on the photocathode. The photocathode is air tolerant, is made of a material selected of Na₂O, K₂O and Rb₂O, and is configured to convert the light beam to an electron beam. The electron beam may be sent to an anode that anode is configured to generate an X-ray beam following a generation of the electron beam.

According to an embodiment, the light optics includes a beam shaping unit that is configured to convert an input light beam having a Gaussian beam profile to a converted light beam having an airy disk beam profile.

According to an embodiment, the light optics further includes a focusing unit that is configured to focus the converted light beam to a flat top beam that forms the sub-micron spot on the photocathode.

According to an embodiment, the light beam is a visible light beam having a wavelength within a range of 380 to 532 nanometers.

According to an embodiment, the optics includes a diamond amplified photocathode that is positioned downstream to the photocathode and is configured to amplify an electron beam emitted by the photocathode to provide an amplified electron beam.

According to an embodiment, the amplified electron beam is sent to an anode that is configured to convert the amplified electron beam to the X-ray beam.

According to an embodiment, the diamond amplified photocathode includes a conductive metal element, a diamond film and a hydrogen terminated surface.

According to an embodiment, the photocathode and the light optics are enclosed within a conductive shield that includes an output aperture.

According to an embodiment, at least a part of the diamond amplified photocathode is located within the output aperture.

According to an embodiment, the optics includes a first biasing circuit for introducing an extraction potential between the photocathode and the diamond amplified photocathode.

According to an embodiment, at least a part of the first biasing circuit is enclosed by the conductive shield.

According to an embodiment, the optics includes a second biasing circuit for introducing an acceleration voltage between the anode and the diamond amplified photocathode.

According to an embodiment, the optics includes a vacuum aperture.

There is provided an optics that includes an electron gun using a robust, air-tolerant, high quantum efficiency photocathode such as an M₂O family (M: Na, K, Rb) photocathode that can provide a high current, low thermal emittance electron beam that can be better focused. The low thermal emittance allows to more effectively focus the electron beam and produce a uniform cross-section power distribution at an anode, thus allowing the anode to handle more power and so produce a higher brightness x-ray source more effectively.

An air-tolerant photocathode with high quantum efficiency can also be used to control wafer charging in X-ray photoelectron spectroscopy (XPS) applications.

A high brightness, low thermal emittance electron beams can enable nanometer length scales X-ray imaging systems need for metrology and inspection in semiconductor market.

To produce a higher brightness x-ray source, there is a need to focus the electron beam to a smaller spot and with a uniform cross section so it can generate more x-rays per solid angle.

The current solution uses a new family of photocathodes called anti-fluorite materials, Na₂O, K₂O, Rb₂O, that promises air stability because the presence of Oxygen allows these materials to be stable against oxidation. The use of a photocathode is normally limited because the operating vacuum necessary is extremely low (10⁻¹² Torr or better, where normal gun vacuums are 10⁻⁹ Torr), so it is very difficult to achieve the operating conditions where the photocathode will survive in a production tool.

In accelerators and free electron sources, the operating conditions are met, and the photocathodes have been used successfully to generate high brightness electron beams with a long lifetime. In various metrology tools, the operating vacuum is ~10⁻⁷ Torr and is further contaminated by wafers that come into the chamber every minute full of adsorbed layers of water, and this water is released into the chamber vacuum causing an oxidating environment that will quickly deteriorate the performance of an ordinary photocathode. Because of their oxidize state, the anti-fluorite photocathode is more robust in these conditions and hence brings the photocathode into the operating realm of various metrology tools.

The photocathode is termed air tolerant as it can withstand operating at a vacuum level of about 10⁻⁷ (or more) Torr which is also contaminated by wafers.

In the current solution the alkali antimonide photocathodes such as K2CsSb are replaced by photocathodes of the M₂O (M: Na, K, Rb) family. M₂O family includes Na₂O, K₂O, Rb₂O.

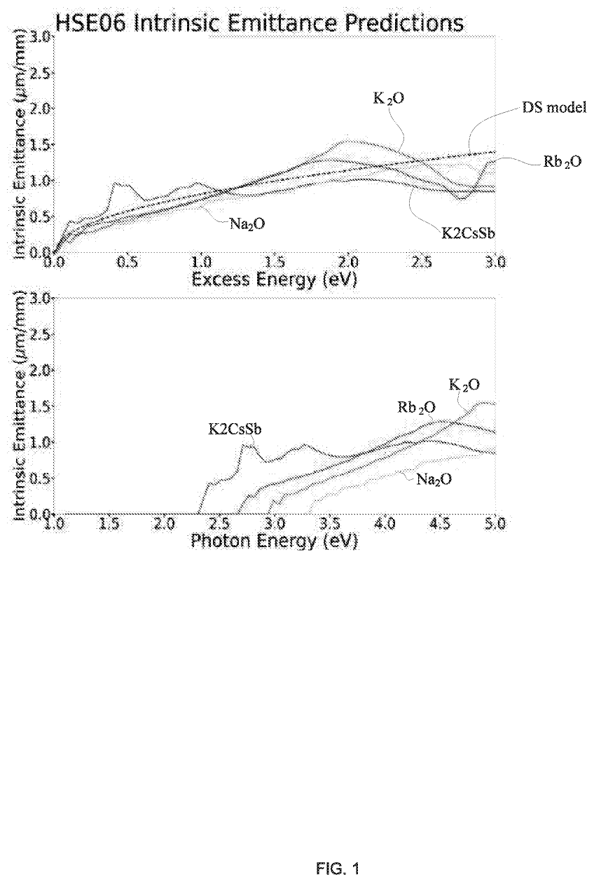

It has been found that the M₂O family exhibits intrinsic thermal emittance comparable to K2CsSb but with the additional benefit of superior air stability (FIG. 1). Even though the presence of oxide anions in the M₂O family allows them to be stable against oxidation, their ionic nature is also likely to be responsible for the higher band gap of the M₂O family, relative to K2CsSb.

The M2O (M: Na, K, Rb) anti-fluorite family has also been found to exhibit low thermal emittance when illuminated by a visible light laser in the 2.33 eV to 3.26 eV energy range (380 nm to 532 nm).

Photocathodes that can operate with visible light driving lasers are preferred since they can be illuminated by the second harmonic of Nd:YAG lasers and can lead to high spatial quality beams. Nd:YAG lasers can also work on Continuous Wave (CW) or pulsed (Q-switched) modes.

A transmission-mode M₂O Photocathode film illuminated by a flat-top laser or LED beam in the 2.33 eV to 3.26 eV energy range (380 nm to 532 nm) can produce a flat-topped electron beam with a very low thermal emittance (FIG. 1)—for example below 1.5 micron/millimeter.

According to an embodiment, laser beam shaping optics is used to convert Gaussian-shaped laser beam profiles to flat top beam profiles. Refractive beam shapers allow for uniformity in the distribution of intensity and flat phase fronts.

According to an embodiment, the beam shaper is the refractive ADLOPTICA FOCAL-ΠSHAPER Q FLAT TOP BEAM SHAPERS™ of EDMUND OPTICS INC.™ of Barrington New Jersy that converts an input Gaussian beam to a collimated airy disk profile. This forms a flat top focused spot after focusing through a diffraction-limited lens. The compact design and their near 100% efficiency on these components make them easy to integrate into the suggested air-resistant photocathode electron gun.

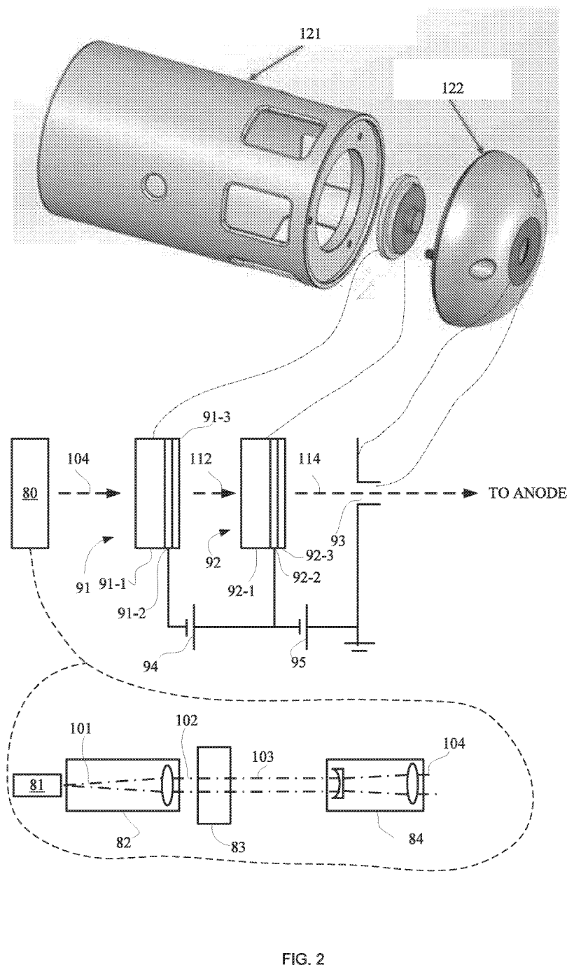

FIG. 2 illustrates the light optics 80 that include a light source 81 that outputs an input light beam 101 that is collimated by collimator 82 to provide a collimated light beam 102 that has a Gaussian beam profile.

The collimated light beam 102 is beam shaped by beam shaper 83 (such as the refractive ADLOPTICA FOCAL-ΠSHAPER Q FLAT TOP BEAM SHAPER) to provide a shaped light beam 103 having an airy disk profile that is focused by focusing unit 84 to provide a focused beam 104 having flat top beam profile which forms a small, uniform spot on the photocathode. Thus, a higher brightness x-ray source can be produced with the same anode structure. The Photocathode can be incorporated into a source assembly.

FIG. 2 also illustrates a conductive shield 121 and a cap 122 that has output aperture 93.

FIG. 2 further illustrates a diamond amplified photocathode 92 that is located downstream to photocathode 91. The diamond amplified photocathode 92 amplifies the electron beam 112 outputted from the photocathode 91 to provide an amplified electron beam 114 that passes through the output aperture 93 and impinges on an anode (not shown in FIG. 2).

In FIG. 2, the photocathode 91 is illustrated as including a fused silica optic 91-1, a conductive metal element 91-2 such as a platinum underlayer, and a photocathode layer 91-3 (made of at least one of the M2O (M: Na, K, Rb) anti-fluorite family members).

In FIG. 2, the diamond amplified photocathode 92 is illustrated as including conductive metal element 92-1, diamond film 92-2 and a hydrogen terminated surface 92-3.

In FIG. 2 the photocathode 91 and the diamond amplified photocathode 92 are integrated together and at least a part of the diamond amplified photocathode 92 is located within the output aperture 93.

FIG. 2 also illustrates (a) a first biasing circuit 94 that is configured to introduce an extraction potential between the photocathode and the diamond amplified photocathode, and (b) a second biasing circuit 95 that is configured to introduce an acceleration field between the diamond amplified photocathode and the anode.

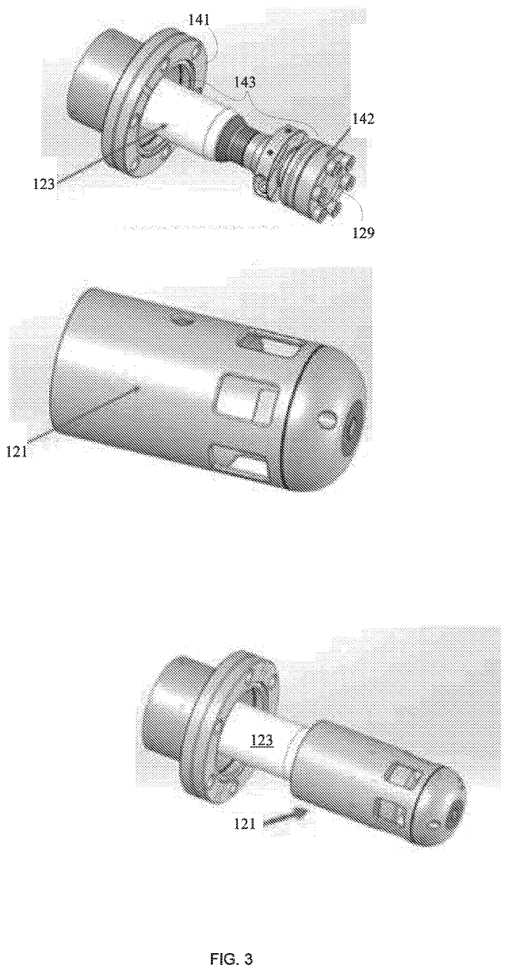

FIG. 3 illustrates that various optics components such as the voltage insulator 123 and light optics (located within an intermediate region 143—that is positioned between first plunge 141 and second plunge 142) are enclosed by the conductive shield 121. FIG. 3 also illustrates vacuum aperture 129.

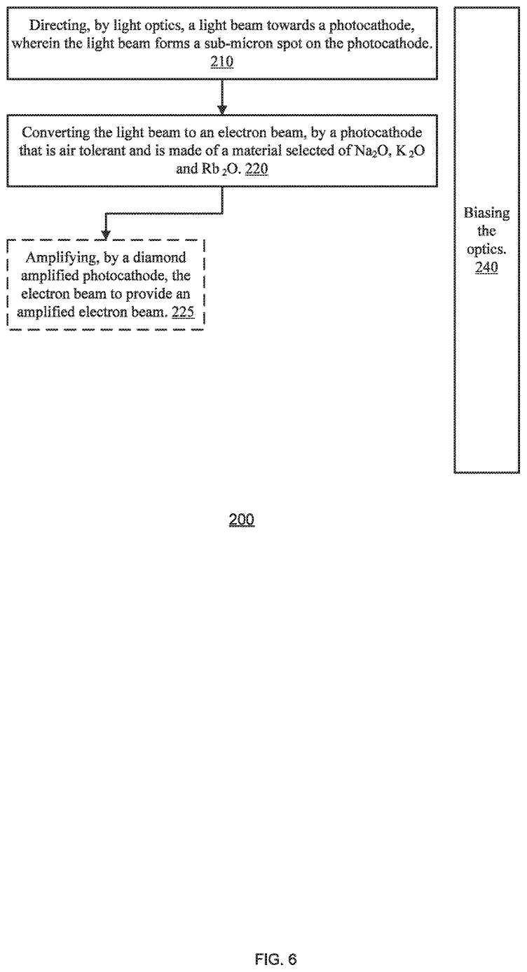

The modified high voltage stem assembly will allow flat-topped visible light driving laser or LED illumination from the backside, as illustrated in the lower part of FIG. 6.

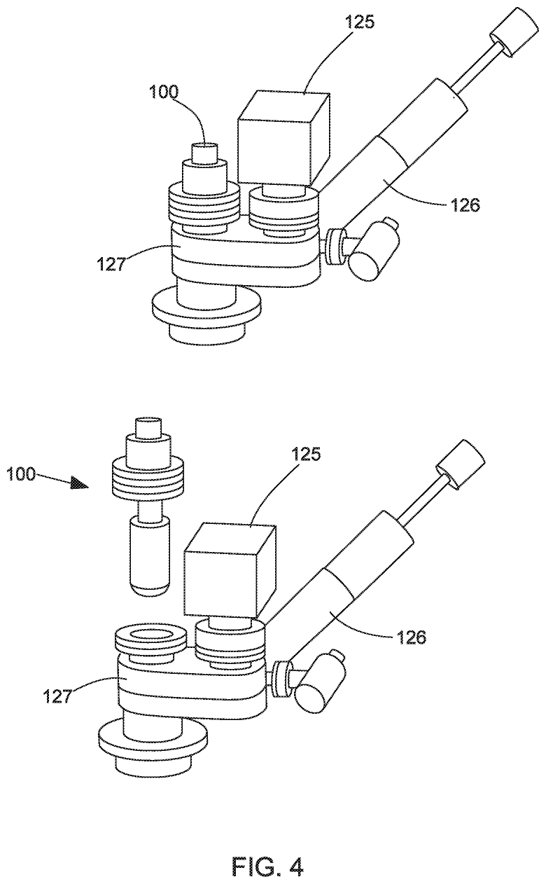

FIG. 4 illustrates examples of compact photocathode electron guns that include a sub-unit 100 that includes at least the photocathode, the light optics, the conductive shield and the cap. The photocathode electron guns also include isolation valve actuator 126, and ion/getter pump 125 that forms vacuum within a gun vacuum manifold 127. The vacuum experienced by the photocathode is set by the pressure level within the gun vacuum manifold 127.

The isolation valve actuator 126 is configured to maintain the environment of the photocathode as clean as possible.

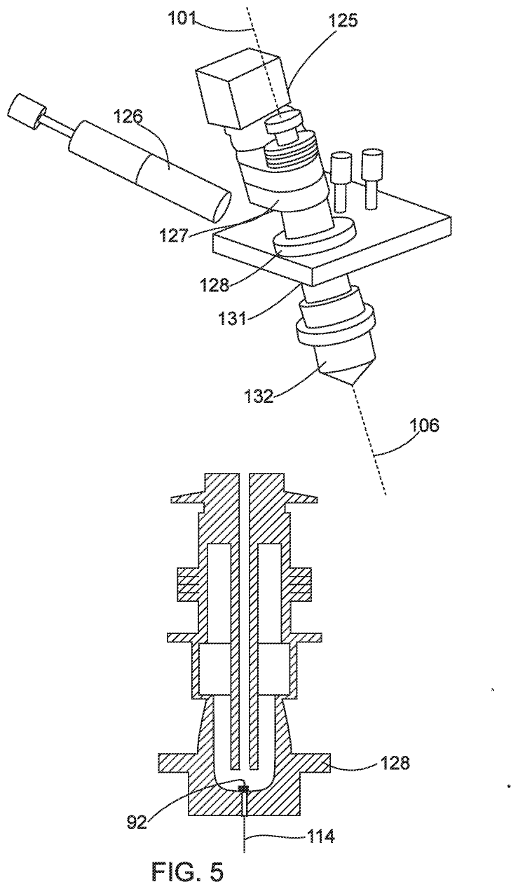

FIG. 5 illustrates a photocathode electron gun that includes sub-unit 100 (that includes at least the photocathode, the light optics, the conductive shield and the cap), ion/getter pump 125 that forms vacuum within a gun vacuum manifold 127, an input cable 124, an isolation valve actuator 126 and a structural element 128 that interfaces with the cap 122, a plate 130 in connection to the structural element 138 and an amplified electron beam output optical element 132.

According to an embodiment the photocathode is a transmission photocathode.

According to an embodiment the photocathode is a reflection photocathode.

According to an embodiment, the optics is configured to generate an X-ray beam for various usages—for example for metrology application and/or inspection applications in semiconductor industry.

According to an embodiment, the optics is used for controlling wafer charging in XPS applications.

According to an embodiment, the optics is used as an X-ray beam source for electron beam metrology applications and/or for and inspection applications in semiconductor industry.

According to an embodiment, the optics includes a high-brightness electron source that increases a throughput of a system that includes the optics.

FIG. 6 is an example of method 200 for generating an X-ray beam.

According to an embodiment, method 200 starts by step 210 of directing, by light optics, a light beam towards a photocathode, wherein the light beam forms a sub-micron spot on the photocathode.

According to an embodiment, step 210 is followed by step 220 of converting the light beam to an electron beam, by a photocathode that is air tolerant and is made of a material selected of Na₂O, K₂O and Rb₂O.

According to an embodiment, method 200 is followed by generating, by an anode, the X-ray beam following a generation of the electron beam.

According to an embodiment, step 210 includes converting, by beam shaping unit of the light optics, an input light beam having a Gaussian beam profile to a converted light beam having an airy disk beam profile, and focusing, by a focusing unit of the light optics, the converted light beam to a flat top beam that forms the sub-micron spot on the photocathode.

According to an embodiment, step 220 includes converting, by the anode, the electron beam to the X-ray beam.

According to an embodiment, method 200 includes step 225 of amplifying, by a diamond amplified photocathode, the electron beam to provide an amplified electron beam. In this case, method 200 is followed by converting, by the anode, the amplified electron beam to the X-ray beam.

According to an embodiment, the diamond amplified photocathode includes a conductive metal element, a diamond film and a hydrogen terminated surface.

According to an embodiment, the photocathode and the light optics are enclosed within a conductive shield that includes an output aperture.

According to an embodiment, at least a part of the diamond amplified photocathode is located within the output aperture.

According to an embodiment, method 200 also includes step 240 of biasing the optics.

According to an embodiment step 240 includes introducing, by a first biasing circuit, an extraction potential between the photocathode and the diamond amplified photocathode.

According to an embodiment, step 240 also includes introducing, by a second biasing circuit, an acceleration field between the diamond amplified photocathode and the anode. According to an embodiment, the extraction field is about 3 Kv (other values may be applied) and the acceleration field is about 19 Kv.

According to an embodiment, at least a part of the first biasing circuit is enclosed by the conductive shield.

According to an embodiment, the conductive shield and the voltage insulator are aimed to shield the environment of the optics from the extraction field and/or the acceleration field.

According to an embodiment, the optics includes a vacuum aperture.

According to an embodiment, the light beam is a visible light beam having a wavelength within a range of 380 to 532 nanometers.

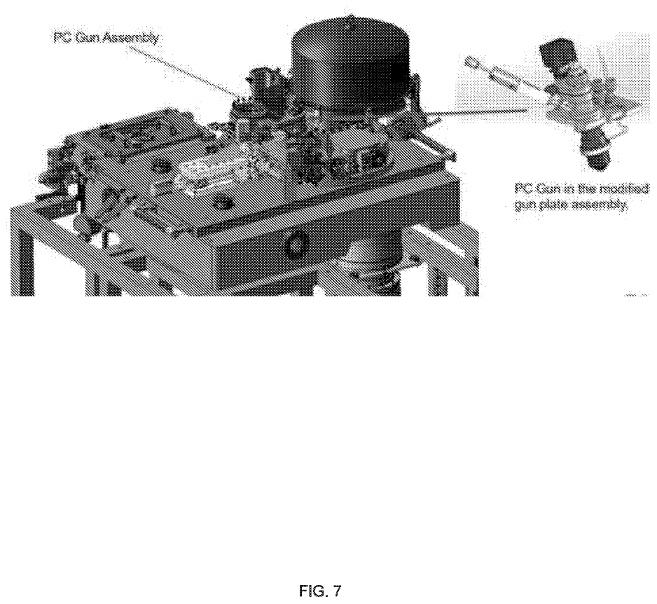

FIG. 7 is an example of a position of the photocathode gun in a system such as the VERAFLEX™ of Nova Ltd. Of Rehovot Israel.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

Any reference in the specification to a system should be applied mutatis mutandis to a method that may be executed by the system

[symbol]

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim

1. Optics for use in X-ray generation, the optics comprising:
a photocathode; and
light optics configured to direct a light beam towards the photocathode, wherein the light beam forms a sub-micron spot on the photocathode;
wherein the photocathode is air tolerant, is made of a material selected of Na₂O, K₂O and Rb₂O, and is configured to convert the light beam to an electron beam.

2. The optics according to claim 1, wherein the light optics comprises a beam shaping unit that is configured to convert an input light beam having a Gaussian beam profile to a converted light beam having an airy disk beam profile.

3. The optics according to claim 2, wherein the light optics further comprises a focusing unit that is configured to focus the converted light beam to a flat top beam that forms the sub-micron spot on the photocathode.

4. The optics according to claim 1, wherein the light beam is a visible light beam having a wavelength within a range of 380 to 532 nanometers.

5. The optics according to claim 1, further comprising a diamond amplified photocathode that is positioned downstream to the photocathode and is configured to amplify the electron beam to provide an amplified electron beam.

6. The optics according to claim 5, wherein the diamond amplified photocathode comprises a conductive metal element, a diamond film and a hydrogen terminated surface.

7. The optics according to claim 5, wherein the photocathode and the light optics are enclosed within a conductive shield that comprises an output aperture.

8. The optics according to claim 7, wherein at least a part of the diamond amplified photocathode is located within the output aperture.

9. The optics according to claim 7, further comprising a first biasing circuit for introducing an extraction potential between the photocathode and the diamond amplified photocathode.

10. The optics according to claim 9, wherein at least a part of the first biasing circuit is enclosed by the conductive shield.

11. The optics according to claim 1, comprising a vacuum aperture.

12. A method for generating an electron beam for use in X-ray generation, the method comprising:
directing, by light optics, a light beam towards a photocathode, wherein the light beam forms a sub-micron spot on the photocathode; and
converting the light beam to an electron beam, by a photocathode that is air tolerant and is made of a material selected of Na₂O, K₂O and Rb₂O.

13. The method according to claim 12, further comprising converting, by beam shaping unit of the light optics, an input light beam having a Gaussian beam profile to a converted light beam having an airy disk beam profile.

14. The method according to claim 13 further comprising focusing, by a focusing unit of the light optics, the converted light beam to a flat top beam that forms the sub-micron spot on the photocathode.

15. The method according to claim 12, further comprising amplifying, by a diamond amplified photocathode, the electron beam to provide an amplified electron beam; wherein the generating of the X-ray beam comprises converting, by the anode, the amplified electron beam to the X-ray beam.

16. The method according to claim 15, wherein the diamond amplified photocathode comprises a conductive metal element, a diamond film and a hydrogen terminated surface.

17. The method according to claim 15, wherein the photocathode and the light optics are enclosed within a conductive shield that comprises an output aperture.

18. The method according to claim 17, wherein at least a part of the diamond amplified photocathode is located within the output aperture.

19. The method according to claim 15, further comprising introducing, by a first biasing circuit, an extraction potential between the photocathode and the diamond amplified photocathode.

20. The method according to claim 12, wherein the light beam is a visible light beam having a wavelength within a range of 380 to 532 nanometers.
